(19) United States
(12) Patent Application Publication
(10) Pub. No.: US 2007/0106595 A1
(43) Pub. Date: May 10, 2007

(54) Monitoring tool for integrated product ordering/fulfillment center and auction system

(75) Inventors: Yan Cui, Sunnyvale, CA (US); Rowell Sotto, Mountain View, CA (US); Lenin K. Subramanian, Palo Alto, CA (US); Narinder Singh, Sunnyvale, CA (US); Anisha Dadhia, San Jose, CA (US)

Correspondence Address: KENYON & KENYON LLP, 1500 K STREET N.W., WASHINGTON, DC, 20005, US

(73) Assignee: SAP AG

(21) Appl. No.: 11/591,132

(22) Filed: Oct. 31, 2006

Related U.S. Application Data
(60) Provisional application No. 60/731,258, filed on Oct. 31, 2005.

(51) Int. Cl. G06Q 40/00

(52) U.S. Cl. 705/37

(57) ABSTRACT

An administrative tool is provided for auction systems in which auction sellers are permitted to monitor, access and modify their instructions. An enterprise network includes a communication manager, a product ordering/fulfillment application to respond to electronic product purchase requests and initiate fulfillment thereof, the product ordering/fulfillment manager supported by a database representing products available for purchase, an auction manager to manage on-line auctions of products and to respond to electronic bids submitted for products available for purchase, the auction manager supported by a database storing auction records representing the on-line auctions, the auction records including pointers to products from the database of the product ordering/fulfillment manager. A monitoring tool integrated with the auction manager provides statistical information of the on-line auctions to an enterprise representative and permits the representative to control select auctions.

### BACKGROUND

Sellers of goods and services often use computer systems to manage their operations. Some of them use product ordering and fulfillment applications to store data representing their products, to maintain data of product inventory as it changes over time, to manage data regarding their customers (including for example, an identification of which products are eligible for purchase by each customer) and to maintain price books, which determine what prices are to be offered to individual customers.

Sellers often seek to find alternative ways to sell their products. Recently, interest has developed in automated auctions for products. Automated auction systems typically are maintained by an auctioneering authority, a company which has no predetermined affiliation with various sellers who use the conventional product ordering and fulfillment applications. While sellers can manually open auctions and define terms under which they will sell their products in an auction, the manual operations are cumbersome. They do not provide a convenient means for a seller to identify its products and publish information about them and they do not integrate with the data structures already available to sellers via the product ordering and fulfillment centers that many of them maintain on their own. Accordingly, there is a need in the art for an enterprise system providing an auction system that is integrated with seller's product ordering and fulfillment systems. There is a need in the art for such a system that provides secure communication between the auction system and the product ordering and fulfillment systems. There further is a need in the art for such an integrated system that provides a monitoring tool to permit sellers to review, control and possibly modify auctions as they occur.

### BRIEF DESCRIPTION OF THE DRAWINGS

FIG. 1 is a screen shot of a search tool according to an embodiment of the present invention.

FIG. 2 is a screen shot of a search results user interface according to an embodiment of the present invention.

FIG. 3 is a screen shot of a detail view of an auction record according to an embodiment of the present invention.

FIG. 4 is a screen shot of an auction record editor according to an embodiment of the present invention.

FIG. 5 is screen shot of a detail view of an auction record for an active auction according to an embodiment of the present invention.

FIG. 6 is screen shot of a detail view of a bid history for an auction record according to an embodiment of the present invention.

FIG. 7 is screen shot of a detail view of an auction record for a closed auction according to an embodiment of the present invention.

FIG. 8 is screen shot of a winner selection tool for a closed auction according to an embodiment of the present invention.

FIG. 9 is screen shot of a detail view of an auction record according to an embodiment of the present invention.

### DETAILED DESCRIPTION

Embodiments of the present invention introduce an administrative tool for auction systems in which auction sellers are permitted to monitor, access and modify their instructions. An enterprise network includes a communication manager, a product ordering/fulfillment application to respond to electronic product purchase requests and initiate fulfillment thereof, the product ordering/fulfillment manager supported by a database representing products available for purchase, an auction manager to manage on-line auctions of products and to respond to electronic bids submitted for products available for purchase, the auction manager supported by a database storing auction records representing the on-line auctions, the auction records including pointers to products from the database of the product ordering/fulfillment manager. A monitoring tool integrated with the auction manager provides statistical information of the on-line auctions to an enterprise representative and permits the representative to control select auctions.

A seller may engage an auction monitor unit via a portal-based communication session between a client terminal and a server. In this system, the client and terminal would be members of a common enterprise network. When the seller engages the server, the auction monitor unit presents an introductory page from which the seller may navigate to additional monitoring tools. One of the most basic monitoring tools provides an opportunity to search for and display auctions that meet selection criteria.

FIG. 1 illustrates an exemplary user interface 100 for a search tool. There, user interface 100 provides several fields 110-140 to permit an operator to search based on auction name 110, auction status 120, auction type 130 and various data parameters 140—auction start dates and/or close dates. When a search button 150 is invoked, the system performs the search on auction data records stored by the system.

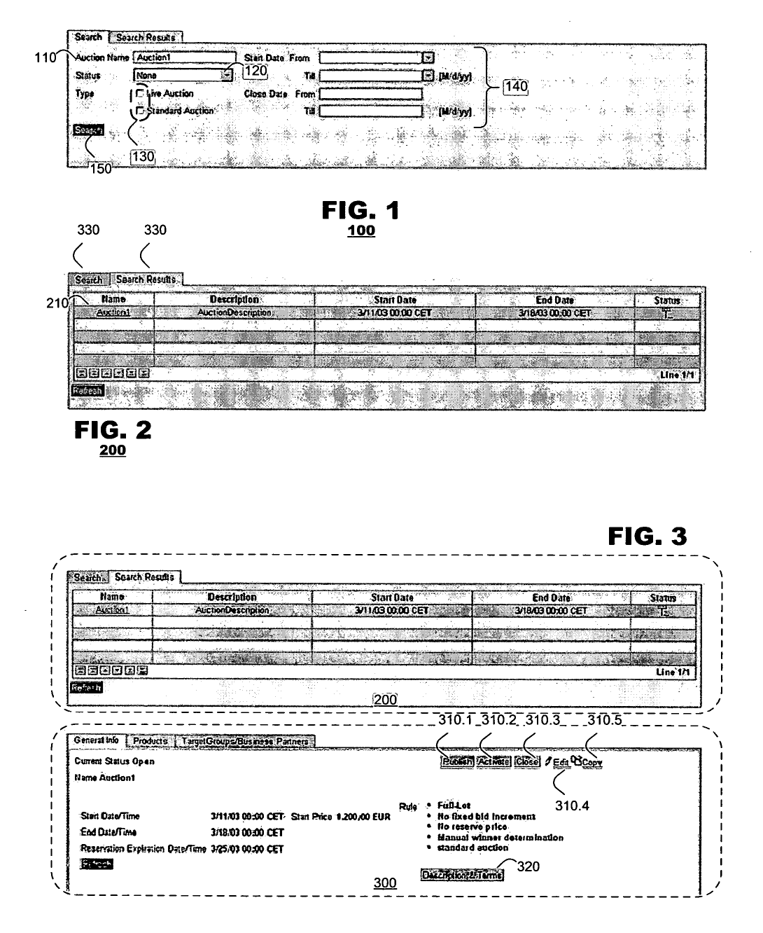

FIG. 2 illustrates exemplary search results that may be obtained as a result of a search. There, the interface 200 displays various fields of auctions stored by the system in a tabular array. The name 210 of the auction may be represented by a hyperlink to a detail view of a data record representing the auction. In the display of FIG. 2, the most pertinent summary information of each responsive auction is displayed, including for example the auctions' status, start and end dates and a summary description of the items offered by the auction.

Displays of both the search screen and the search results screen may include tabs 220, 230 to permit an operator to navigate between the screens as desired and to identify which of the two screens is active at each moment in time.

FIG. 3 illustrates a user interface that may be provided when a detail view is selected from the search results of FIG. 2. In FIG. 3, the search results interface 200 may persist in a first area of the display and a detail view 300 for selected auction record may be provided in a another area of the display. The detail view 300 may display fields representing the auction start and end times, and provide details regarding parameters of the auction itself and/or details of the items offered under the auction.

The detail view 300 also may provide a number of action buttons 310.1-310.5 representing actions that may be performed on the auction record. In the example of FIG. 3, the action buttons represent publication of an auction 310.1, activation of an auction 310.2, closing of an auction 310.3, editing of an auction 310.4 and copying of an auction 310.5. When an auction is published 310.1, notifications are sent to all members of target groups for whom the auction is intended. When an auction is activated, the system alters its state to identify it as a ‘live’ auction. When an auction is closed, the system concludes the auction even if its specified closing time has not been reached. When an auction is edited, the seller may revise auction parameters. When an auction is copied, the system creates a duplicate auction record from the auction record currently being viewed and opens an editor to permit the seller to revise the auction parameters. The detail view 300 also may include buttons 320, 330 to view still other details of auction records.

FIG. 4 illustrates an interface 400 that may be employed to permit sellers to edit auctions. There the interface 400 displays auction parameters 410 across a variety of screens. For example, general auction parameters such as name, description and start and end times may be displayed in a general information screen. Data regarding the products offered under the auction may be displayed in a product information screen. The data may include, for examples, references to product information in a product catalog database maintained by the seller's CRM application other business application (not shown). Data regarding business partners who are eligible to participate in the auction may be displayed in a target partner information screen. Operators may access the various information screens via navigation tools 420, 430, 440 (such as tabs) via the interface 400. The interface 400 also may have control buttons to permit operators to cancel or save various changes to the auction record or to continue with the monitoring tool, which effectively disengages the auction editing tool.

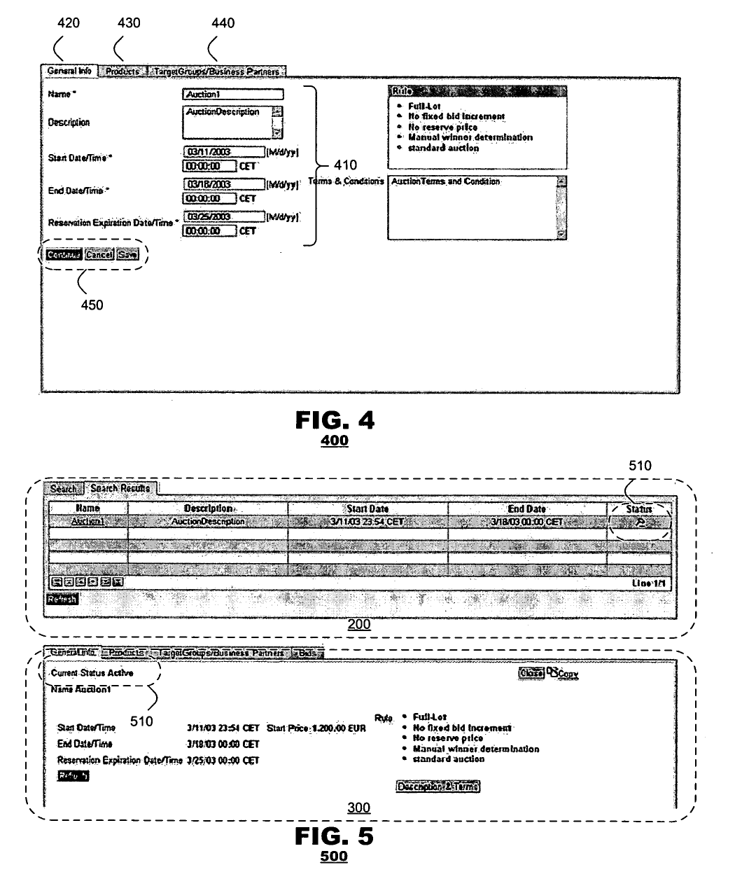

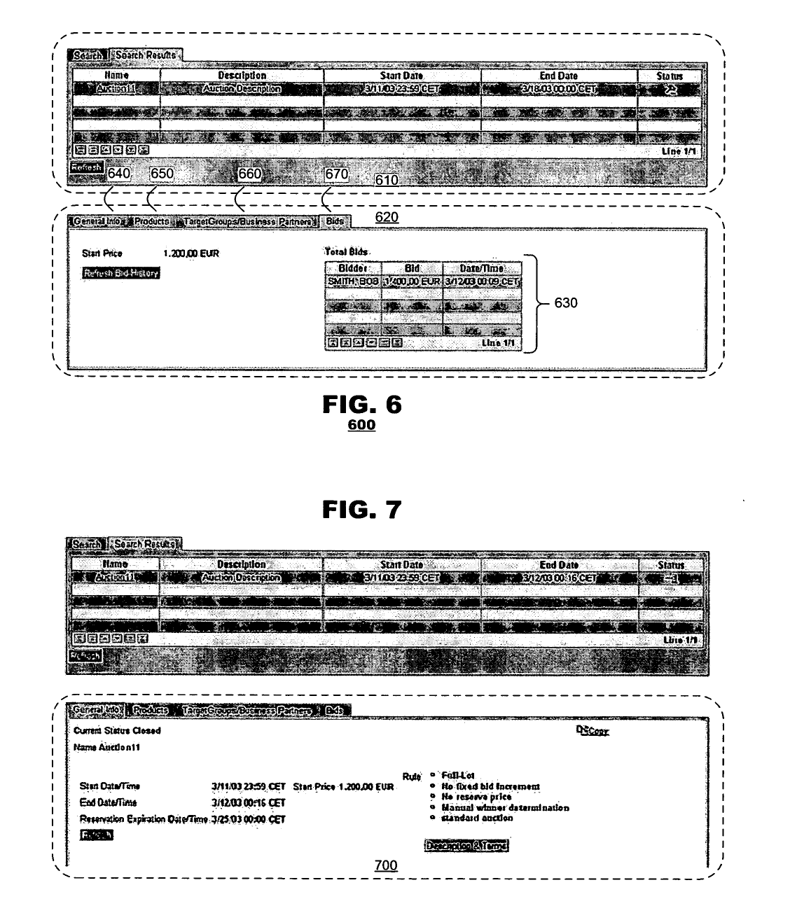

As noted above with respect to FIG. 3, when an auction is activated (signified by a command through the activate button 310.2, the system changes the status of the auction record to reflect that it is a live auction. The auction record data may be changed as is reflected in FIG. 5. The auction's status is reflected in various status fields 510, which can be displayed in the search results area 200 and/or the detailed view area 300 of the user interface 500. In an embodiment, the system may prevent operators from publishing or editing an auction, which is reflected by removing certain control buttons that formerly may have been available for an auction that had not yet become live.

FIG. 6 illustrates an interface 600 that provides a detail view of an auction record for an auction in progress. As shown, the interface 600 may include a search results area 610 and a detailed view area 620. The monitoring tool of the present invention permits a seller to review bid histories and other pertinent data representing activity in an ongoing auction. The bid histories 630 may be displayed in a bids information screen of the display. The bids information screen may not be presented by the monitoring tool for bids that have not yet been activated, however, they can be available for auctions that have expired or been closed affirmatively by an operator. Navigation tools 640-670 permit an operator to navigate between the bids information screen and other data views—the general information screen, the products information screen and the target groups information screen—as desired.

As noted with respect to FIG. 3, the monitoring tool permits a seller to close an auction manually. Further, an auction can close automatically according to the terms specified in the auction record. FIG. 7 illustrates an exemplary detail view 700 of an auction record for a closed auction. The detail view may include a general information screen, a products screen, a target groups screen and a bids screen as in prior embodiments.

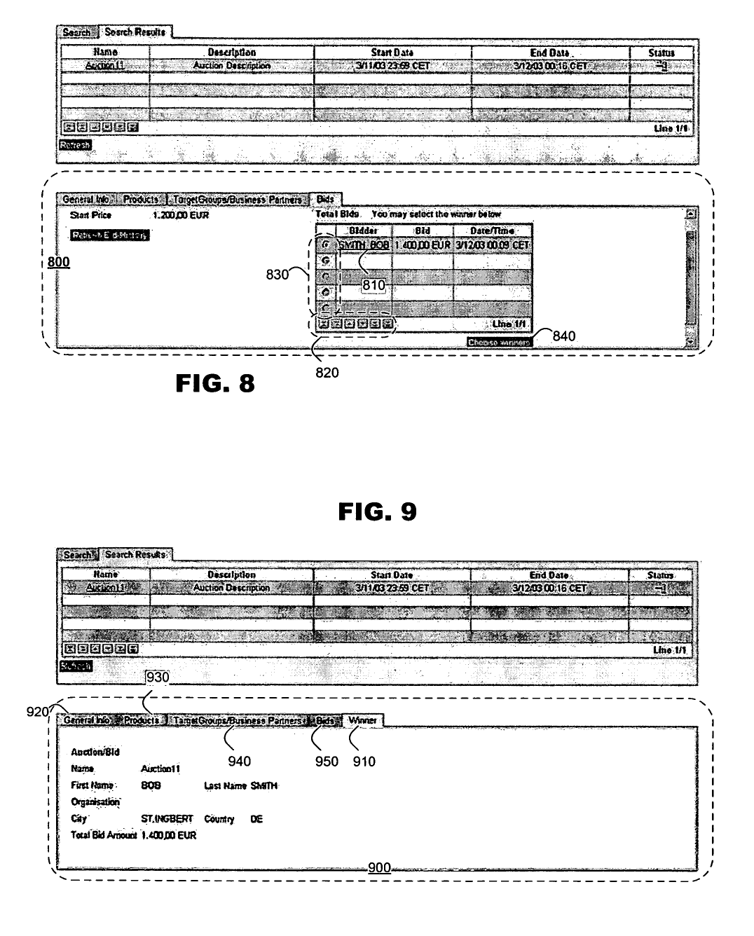

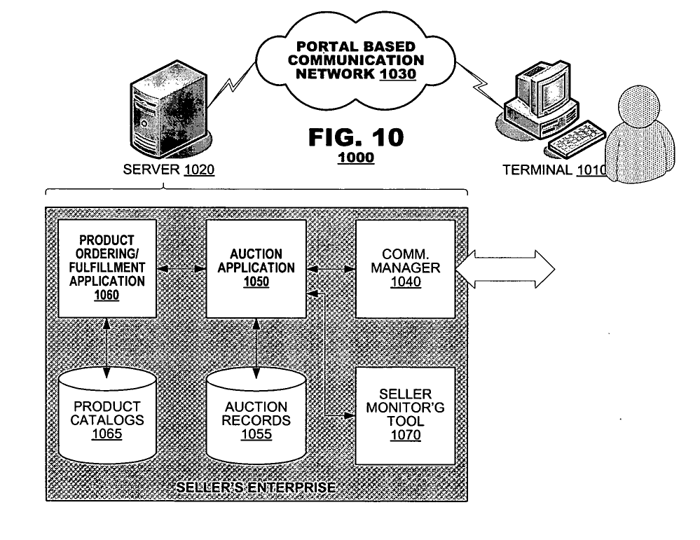

In some cases, bids made under the auction may qualify one or more bidders as the winner of the auction. Auctions may be defined as an automatic type or a manual type. FIG. 8 illustrates an exemplary user interface to permit manual selection of a winning bid. There, the detail view 800 may present a bid history for the auction, identifying general terms under which the bids were placed. Individual bids may include navigation tools 810 (such as hyperlinks) that permit an operator to review bid terms in full detail if desired. The detail view 800 also may provide navigation buttons 820 and control buttons 830 that permit an operator to review a bid history and select a winner from among qualifying bids. The operator may confirm his selection of the auction winner via a command button 840.

If an auction is defined as an automatic type, the system may select a winning bid on its own. Typically, the auction record identifies terms that each bid must satisfy to be eligible to win the auction. For example, the auction may specify a minimum price (called the “reserve”) that must be bid to be eligible to win the auction. The auction record also may define a priority system through which to select one bid from all the eligible bids as the winning bid. Typically, eligible bids are evaluated based on price—the bid with the highest bid price often is the winning bid.

When a winning bid is identified for an auction, a corresponding auction record may be supplemented to reflect the winner. The detail view of the monitoring tool also may be amended to reflect that a winning bid has been identified. FIG. 9 illustrates an exemplary detail view 900 of an auction record having a winning bid. There, the detail view has been supplemented to include a winner information pane 910 that provides information on the winning bid and winning bidder. The detail view also includes navigation tools to the other information panes supported by the monitoring tool—the general information pane 920, the product information pane 930, the target group pane 940 and the bid history pane 950.

As noted, the foregoing monitoring tools and user interfaces may be provided on behalf of an integrated enterprise network operated by a common entity. FIG. 10 illustrates an enterprise network 1000 according to an embodiment of the present invention. There, the network 1000 may include terminals 1010 and servers 1020 interconnected via a portal-based communication network 1030. Although a single terminal 1010 and a single server 1020 are illustrated in FIG. 10, the number of terminals or servers may be varied to accommodate various enterprise installations. For the purposes of the present discussion, the number of components and topology of deployment is immaterial unless otherwise noted.

The servers 1020 execute applications to manage operations of the seller. Operators (employees of the seller) typically manage server operating by logging into the servers 1020 via the terminals 1010 in portal-based communication sessions and entering commands to the servers to control their operation.

The servers 1020 may execute applications representing a communication manager 1040, an auction manager 1050 and a product ordering and fulfillment manager 1060. The communication manager 1040 controls communication with the terminals. When responses to operator commands are required, the communication manager 1040 generates portal pages and delivers them to the terminals. For example, the communication manager delivers portal pages representing the various user interfaces illustrated in FIGS. 1-9 to the terminals.

The auction manager 1050 is an application that generates and administers auctions. The auction manager 1050 generates data records representing parameters of the various auctions maintained by the seller and stores data representing each auction's status. Similarly, the auction manager 1050 stores data representing bids received from various bidder (via a communication process not shown) and, where appropriate, identifies a winning bids for the auctions. Data records representing each auction may be stored in a dedicated auction database.

The product ordering and fulfillment manager 1060 may manage other sales activity of a seller. For example, sellers often offer products for retail sale or for sale to distributors and other channel partners. Product ordering and fulfillment managers 1060 may field electronic purchase requests filed by buyers, may compare orders contained in the requests against data records representing current inventories of a seller's products and initiate fulfillment of the orders if they can be filled. To that extent, product ordering and fulfillment managers 1060 may include functionality to manage data of product inventory, to manage billing and to manage product fulfillment. The product ordering and fulfillment manager 1060 may operate upon data representing a seller's product catalog, which contains data on each product, and may store one or more ‘price books’ representing the prices offered for the seller's products. Additionally, the product ordering and fulfillment manager 1060 may operate data representing the seller's customers their ordering history to determine, for example, which products each customer is eligible to review and what prices are to be charged to each customer for the. seller's products.

The product ordering and fulfillment manager 1060 may generate data records representing the seller's products, its current inventory, price books and customer data. Such data records may be stored, for example, in database 1065.

In one embodiment, the product ordering and fulfillment manager 1060 may be a customer relationship management application

For ease of illustration, the monitoring tool of the foregoing embodiments is illustrated as a unit 1070 separate from the auction manager 1050. In many instances, however, the monitoring tool 1070 may be provided as a function module within the auction manager 1050. It may be provided as a fully integrated component of the auction manager 1050.

As noted, the auction manager 1050 and the product ordering and fulfillment manager 1060 may be provided in a common enterprise network. As such, the auction manager 1050 and product ordering and fulfillment manager 1060 may be integrated in a manner that previously has not been possible in auction systems. For example, rather than store product information expressly in an auction record, auction records in the present system may include pointers to corresponding product records maintained by the product ordering and fulfillment manager 1060. Additionally, an auction may be defined to be contingent upon events that can only be determined by the product ordering and fulfillment manager 1060, such as numbers of units currently held in inventory. Accordingly, the integrated system is believed to provide an advance over prior systems where no such integration is possible.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. An enterprise network, comprising:
a communication manager,
a product ordering/fulfillment application to respond to electronic product purchase requests and initiate fulfillment thereof, the product ordering/fulfillment manager supported by a database representing products available for purchase,
an auction manager to manage on-line auctions of products and to respond to electronic bids submitted for products available for purchase, the auction manager supported by a database storing auction records representing the on-line auctions, the auction records including pointers to products from the database of the product ordering/fulfillment manager, and
a monitoring tool integrated with the auction manager to provide statistical information of the on-line auctions to an enterprise network owner.

2. The enterprise network of claim 1, wherein the statistical information includes a bid history for a selected auction.

3. The enterprise network of claim 1, wherein the statistical information includes a summary of auction information for a selected auction.

4. The enterprise network of claim 1, wherein the statistical information includes a winning bidder for a selected auction.

5. The enterprise network of claim 1, wherein the statistical information includes product information for a selected auction.

6. The enterprise network of claim 5, wherein the product information is stored in the database of the product ordering/fulfillment manager.

7. The enterprise network of claim 1, wherein the monitoring tool provides an editing tool to permit an enterprise representative to modify auction parameters.

8. The enterprise network of claim 1, wherein the monitoring tool provides an command means to permit an enterprise representative to activate a selected auction.

9. The enterprise network of claim 1, wherein the monitoring tool provides an command means to permit an enterprise representative to close a selected auction.

10. The enterprise network of claim 1, wherein the monitoring tool provides an command means to permit an enterprise representative to select a winning bid from among a plurality of eligible bids.

11. The enterprise network of claim 1, wherein the monitoring tool provides an command means to permit an enterprise representative to search for a selected auction.
